(19) United States
(12) Patent Application Publication
(10) Pub. No.: US 2022/0160072 A1
(43) Pub. Date: May 26, 2022

(54) INSOLE-TYPE ELECTRONIC DEVICE AND METHOD FOR MANUFACTURING INSOLE-TYPE ELECTRONIC DEVICE

(71) Applicant: NEC Corporation, Minato-ku, Tokyo (JP)

(72) Inventors: Kyoko OTSUKA, Tokyo (JP); Takeshi ITOU, Tokyo (JP); Yuuki MOMOKAWA, Tokyo (JP)

(73) Assignee: NEC Corporation, Minato-ku, Tokyo (JP)

(21) Appl. No.: 17/430,839

(22) PCT Filed: Feb. 19, 2020
(86) PCT No.: PCT/JP2020/006571

§ 371 Date: Aug. 13, 2021

(30) Foreign Application Priority Data
Mar. 25, 2019 (JP) 2019-055971

(51) Int. Cl. A43B 3/46; A43B 3/38; A43B 3/48; A43B 17/14; A43B 17/16

(52) U.S. Cl. CPC A43B 3/46; A43B 3/38; A43B 17/16; A43B 17/14; A43B 3/48

(57) ABSTRACT

Provided is an insole-type electronic device wherein the electronic module is not susceptible to impact and/or load due to walking or running. The insole-type electronic device is an electronic device wherein an electronic module has been incorporated in the insole that is laid on the midsole of a shoe and contacts the sole of the foot. The insole-type electronic device has an insole body with the shape of a normal insole. Said insole body has a heel-protecting part that extends upward from the back end of the heel section of the insole body along the perimeter of the back end of the heel section. Additionally, the insole-type electronic device has an electronic module that is housed in the heel-protecting part.

### TECHNICAL FIELD

The present invention relates to an insole-type electronic device and a method for manufacturing the insole-type electronic device.

### BACKGROUND ART

In recent years, it has become popular to wear an electronic device and acquire biometric information, location information, and the like. One of methods for wearing an electronic device is to incorporate the electronic device into a shoe. This method requires not disturbing an action of a user and not causing discomfort due to wearing.

A technique for meeting this requirement is disclosed, for example, in PTL 1. In the technique, a housing (cavity) is provided under a top surface of a midsole in a shoe or on an insole surface facing the midsole, and an electronic module is housed inside the housing. This configuration prevents discomfort due to wearing. Further, a method of filling a gap between the electronic module and the housing with a shock-absorbing material and thus further preventing discomfort is also disclosed.

Further, PTL 2 discloses a method of configuring a portable device for location search by providing a chamber in a heel (heel portion of an outsole) of a shoe and housing a global positioning system (GPS) receiver or a communication device in the chamber. By housing the electronic device in the heel of the shoe, location information of a user can be acquired without disturbing an action of the user.

### CITATION LIST

### Patent Literature

[PTL 1] Japanese Unexamined Patent Application Publication No. 2015-033643

[PTL 2] Japanese Unexamined Patent Application Publication No. 2000-028698

### SUMMARY OF INVENTION

### Technical Problem

However, in the technique of PTL 1, there is a problem that an electronic module is mounted at a position sandwiched between a foot sole and a shoe sole, and hence is damaged by impact caused during walking or running, thereby raising concern about reliability. A method of lessening impact by filling a housing with a shock-absorbing material is also described in PTL 1, however that is not sufficient because impact cannot be completely absorbed. Further, there is a problem that a load is applied even though impact can be reduced.

PTL 2 also has a similar problem. In particular, a heel portion of a shoe is a place where the largest load is applied on a foot sole, and thus damage to an electronic device is also large.

The present invention has been made in view of the above-described problems, and an object of the present invention is to provide an insole-type electronic device in which an electronic module is less susceptible to impact and a load due to walking or running.

### Solution to Problem

In order to solve the above-described problems, an insole-type electronic device according to the present invention is an electronic device in which an electronic module is incorporated in an insole that is placed on a midsole of a shoe and comes into contact with a foot sole. The insole-type electronic device includes an insole body having a shape of an ordinary insole. The insole body includes a heel-protecting portion extending upward from a rear end of a heel portion of the insole body along a perimeter of the rear end of the heel portion. In addition, the insole-type electronic device includes the electronic module being stored in the heel-protecting portion.

### Advantageous Effects of Invention

An advantageous effect of the present invention is to provide an insole-type electronic device in which the electronic module is less susceptible to impact and a load due to walking or running.

### BRIEF DESCRIPTION OF DRAWINGS

FIG. 1 is a perspective view illustrating an insole-type electronic device according to a first example embodiment.

FIG. 2 is a plan view illustrating an insole-type electronic device according to a second example embodiment.

FIG. 3 is a plan view illustrating a relation between an insole body of the insole-type electronic device according to the second example embodiment and a skeleton of a foot.

FIG. 4 is a perspective view illustrating an insole-type electronic device according to a third example embodiment.

FIG. 5 is a plan view illustrating an insole body of the insole-type electronic device according to the third example embodiment.

FIG. 6 is a plan view illustrating placement of a circuit of the insole-type electronic device according to the third example embodiment.

FIG. 7 is a schematic plan view illustrating a circuit configuration of the insole-type electronic device according to the third example embodiment.

FIG. 8 is a side view illustrating the insole-type electronic device according to the third example embodiment.

FIG. 9 is a perspective view illustrating a heel portion of the insole-type electronic device according to the third example embodiment.

FIG. 10 is a side view illustrating an insole-type electronic device according to a fourth example embodiment.

FIG. 11 is a perspective view illustrating a heel portion of the insole-type electronic device according to the fourth example embodiment.

### EXAMPLE EMBODIMENT

In the following, example embodiments of the present invention are described in detail with reference to the drawings. The below-described example embodiments include a technically preferred limitation in order to implement the present invention, however, the scope of the invention is not limited to the following. A similar component in each drawing is assigned with a same number, and thereby the description thereof may be omitted.

### First Example Embodiment

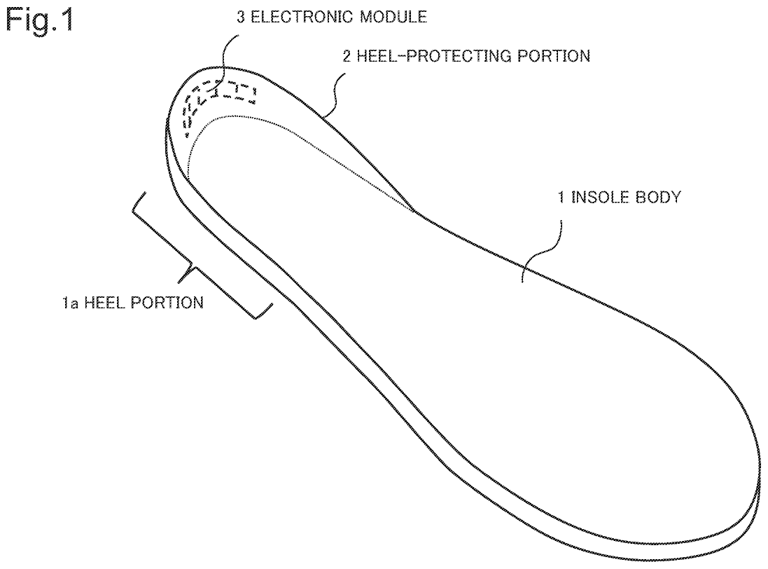

FIG. 1 is a perspective view illustrating an insole-type electronic device according to a first example embodiment. The insole-type electronic device includes a sheet-shaped insole body 1 to be placed on a midsole in a shoe, a heel-protecting portion 2 extending upward from a rear end of a heel portion of the insole body 1, and an electronic module 3 being housed in the heel-protecting portion 2.

According to the present example embodiment, the above configuration is able to provide an insole-type electronic device being less susceptible to impact and a load due to walking or running.

### Second Example Embodiment

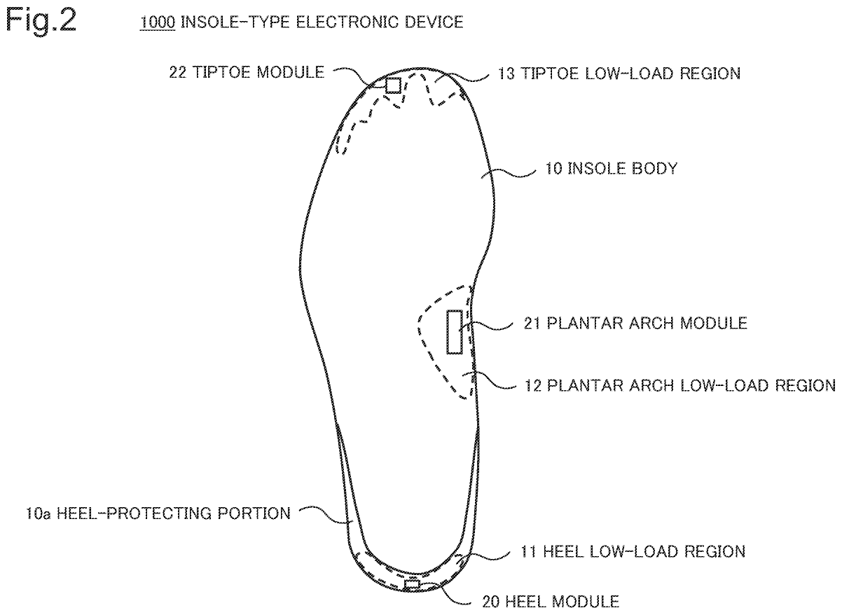

FIG. 2 is a plan view illustrating an insole-type electronic device 1000 according to a second example embodiment. The insole-type electronic device 1000 includes an insole body 10, a heel module 20, a plantar arch module 21, and a tiptoe module 22. According to the present example embodiment, a portion on an instep side other than a sole of a shoe is referred to as an upper, a portion that is combined with the upper and forms an inner sole of a shoe is referred to as a midsole, and a piece of material placed on a top of the midsole and comes into contact with a foot sole is referred to as an insole. In addition, a portion under the midsole that comes into contact with the ground is referred to as an outsole. The insole-type electronic device 1000 is an electronic device in which the electronic modules are incorporated in such an insole.

The insole body 10 includes a heel-protecting portion l0a extending upward in such a way as to surround a rear end of a heel portion. The heel-protecting portion l0a is formed in a heel low-load region 11. The heel module 20 is housed in the heel-protecting portion 10a, in other words, the heel module 20 is placed in the heel low-load region 11 of the insole body 10. The plantar arch module 21 is placed in a plantar arch low-load region 12 of the insole body 10. The tiptoe module 22 is placed in a tiptoe low-load region 13 of the insole body 10. Note that, the heel-protecting portion is also referred to as a heel cup portion.

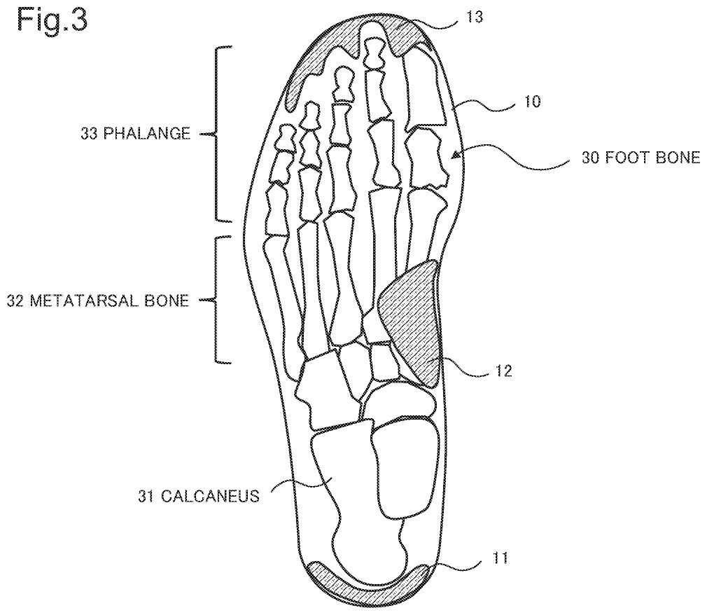

Herein, a low-load region is described. FIG. 3 is a plan view illustrating a relation between the insole body 10 and a skeleton of a human foot. Herein, the skeleton of a human foot is assumed to be a skeleton of a standard person. When a person walks or runs, a load is generated mainly on a lower part of a calcaneus 31 and a lower part on an anterior side of a metatarsal bone 32. In addition, a load smaller than the above is generated on a lower part of a phalange 33 and on a lower part on a lateral side of the metatarsal bone 32. Meanwhile, only a small load is generated on a posterior part of the calcaneus 31, a plantar arch on a medial side of the metatarsal 32, and an anterior part of the phalange 33. Then, according to the present example embodiment, each of the regions where only a small load is generated is defined as the heel low-load region 11, the plantar arch low-load region 12, and the tiptoe low-load region 13.

In the insole-type electronic device 1000 according to the present example embodiment, the heel module 20, the plantar arch module 21, and the tiptoe module 22 are placed in the above-described heel low-load region 11, the plantar arch low-load region 12, and the tiptoe low-load region 13, respectively. Therefore, when a person walks or runs, impact and a load to be applied to the modules are small. The impact and the load are small, and thereby placement of the modules in the low-load regions can avoid worsening a feeling of wearing shoes.

As described above, the present example embodiment is able to provide the insole-type electronic device in which the electronic modules are less susceptible to impact and a load due to walking or running.

### Third Example Embodiment

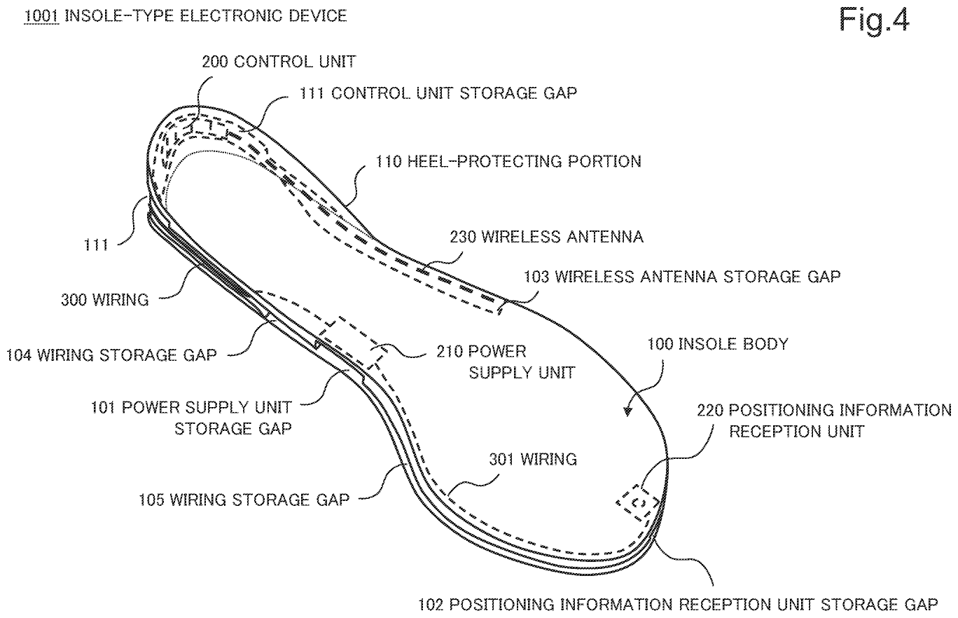

FIG. 4 is a perspective view illustrating an insole-type electronic device 1001 according to a third example embodiment. The insole-type electronic device 1001 includes an insole body 100, a control unit 200, a power supply unit 210, a positioning information reception unit 220, and a wireless antenna 230. The insole-type electronic device 1001 in this configuration is able to notify of a current location of the insole-type electronic device 1001 by receiving positioning information, identifying the current location of the insole-type electronic device 1001, and transmitting the identified current location, to the outside. In other words, a current location of a user wearing the insole-type electronic device 1001 can be notified to the outside. Thereby, for example, a watching system for an elderly person and a child can be configured by using the insole-type electronic device 1001 and a monitoring device that receives and monitors the positioning information of the insole-type electronic device 1001.

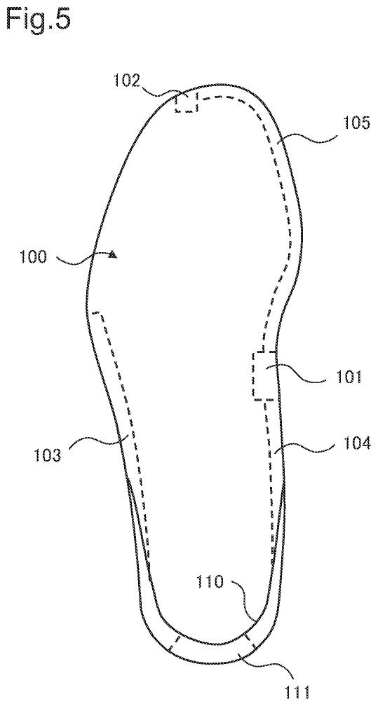

The insole body 100 includes a heel-protecting portion 110 extending upward in such a way as to surround a rear end of a heel portion. FIG. 5 illustrates a plan view of the insole body 100. The insole body 100 includes a control unit storage gap 111 for storing the control unit 200 in the heel-protecting portion 110. Further, the insole body 100 includes a power supply unit storage gap 101 for storing the power supply unit 210 at a plantar arch and a positioning information reception unit storage gap 102 for storing the positioning information reception unit 220 at a tiptoe. Further, the insole body 100 includes a wireless antenna storage gap 1030 for storing the wireless antenna 230, extending forward from the control unit storage gap 111 along a lateral edge of a foot. The insole body 100 also includes a wiring storage gap 104 for storing a wiring 300, extending forward from the control unit storage gap 111 along a medial edge of a foot. In addition, the insole body 100 includes a wiring storage gap 105 for storing a wiring 301, extending from the power supply unit storage gap 101 to the positioning information reception unit storage gap 102.

As a piece of material of the insole body 100, for example, a flexible material such as polyethylene foam, urethane foam, and ethylene-vinyl acetate copolymer (EVA) can be used. These materials are processed into a sheet shape and then formed into an insole shape by presswork, for example. Note that, with respect to a sheet being a base of the insole body, a conductive layer may be formed on a surface that is a back surface of the insole and comes into contact with a shoe. It is possible to use such a conductive layer and provide a ground (GND) on a surface of the insole body 100 that comes into contact with a midsole, although not illustrated in the figure. Such a GND can be formed on the back surface of a resin forming the insole body 100 by laminating a sheet on which the conductive layer is formed and performing laminate pressing, for example. Further, the gap portions for storing the above-described components can be formed by using, for example, a die at the time of pressing.

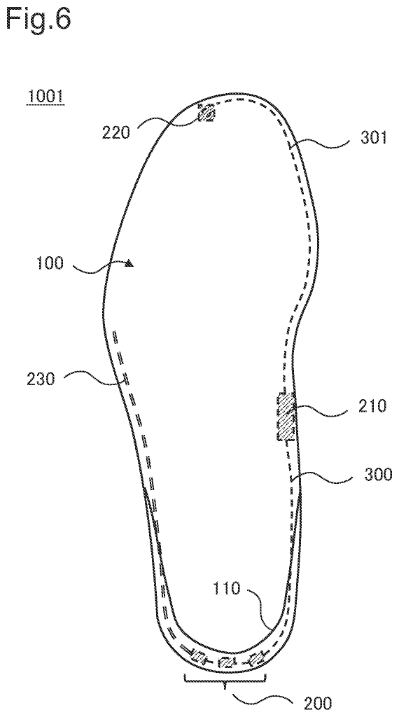

FIG. 6 is a plan view illustrating a circuit configuration of the insole-type electronic device. The circuit of the insole-type electronic device 1001 includes the control unit 200, the power supply unit 210, the positioning information reception unit 220, the wireless antenna 230, and the wirings 300 and 301 for connecting the components one another. The control unit 200 is stored in the control unit storage gap 111, the power supply unit 210 is stored in the power supply unit storage gap 101, and the positioning information reception unit 220 is stored in the positioning information reception unit storage gap 102.

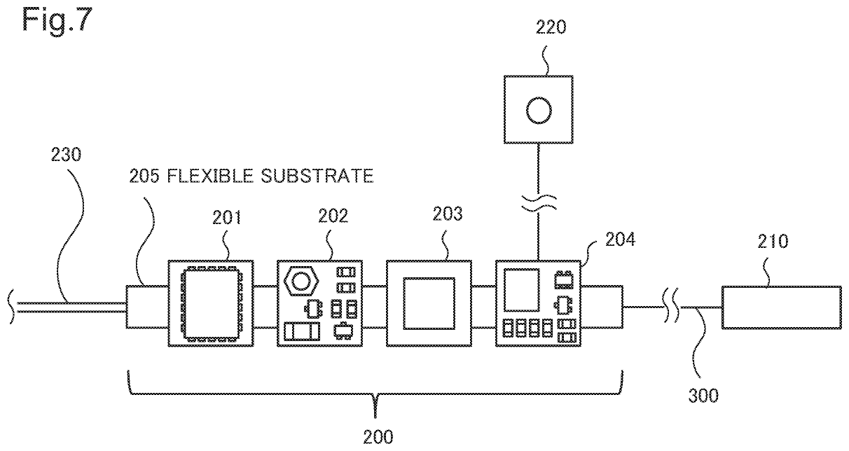

FIG. 7 is a schematic plan view illustrating one example of the circuit configuration of the insole-type electronic device 1001. The control unit 200 incorporates a microcomputer 201, a communication module 202, an amplifier 203, a filter 204, and the like. Each of these components is mounted on a rigid substrate, for example. Then, each component is mounted on a flexible substrate 205, for example. Each component and the flexible substrate 205 are joined by, for example, solder, conductive adhesive, or the like. The flexible substrate 205 on which each component is mounted can be curved and placed along a shape of the heel-protecting portion 110. The power supply unit 210, the positioning information reception unit 220, and the wireless antenna 230 are connected to the control unit 200 via the flexible substrate 205 and other wiring.

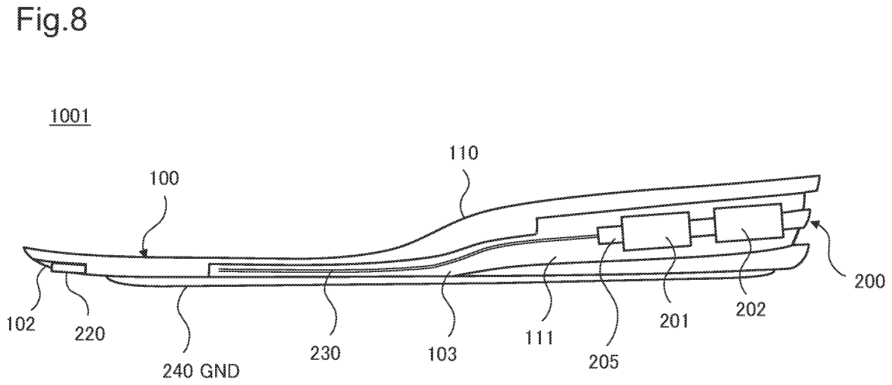

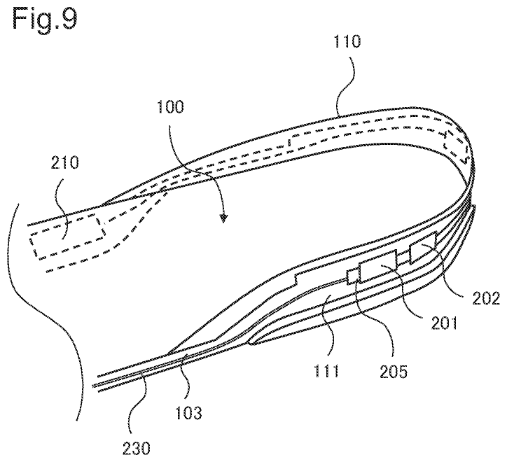

FIG. 8 is a side view illustrating a side surface of the insole-type electronic device 1001. FIG. 9 is a perspective view zooming in the heel portion of the insole-type electronic device 1001. As illustrated in FIGS. 8 and 9, in the insole-type electronic device 1001, the control unit 200 is housed in the control unit storage gap 111, and the flexible substrate 205 is mounted along the shape of the heel-protecting portion 110. Further, a GND 240 is placed at a bottom of the insole body 100. As described above, the GND 240 can be formed by laminating a conductive layer on a resin layer.

Note that, after storing the control unit 200 in the control unit storage gap 111, the power supply unit 210 in the power supply unit storage gap 101, and the positioning information reception unit 220 in the positioning information reception unit storage gap 102, each gap may be covered with, for example, a waterproof/moisture-proof resin having flexibility (not illustrated). A purpose of this is to separate each component (module) from the outside in such a way as to withstand a high-temperature and a high-humidity environment inside a shoe. As such a resin, for example, urethane-based, polymer-based, silicone-based, rubber-based, or acrylic-based fillers can be used.

Next, a reason for the placement of the control unit 200, the power supply unit 210, and the positioning information reception unit 220 is described. First, a reason for placing the control unit 200 along the side surface of the heel-protecting portion 110 is described. A foot bone 30 is composed of 28 bones for one foot including 14 phalanges 33 (finger phalanges, proximal phalanges, middle phalanges, distal phalanges), 5 metatarsal bones 32, 7 tarsal bones, and 2 sesamoid bones (see FIG. 3). Then, deformation is caused in a vicinity of a joint connecting each bone at the time of motion. However, a calcaneus has no joints, and thus there is little change in shape. Further, a foot sole portion of the calcaneus has an R shape, and thus, inside a shoe, there is a gap between the foot sole and a lower part of the heel that connects to an ankle direction. Therefore, a load is small at a position along the side surface of the insole heel-protecting portion 110. By housing the control unit 200 in this portion, it is possible to secure a shape/function as an insole while a circuit is protected from external pressure.

Next, a reason for placing the positioning information acquisition unit 220 in a tiptoe portion is described. The positioning information reception unit 220 can be placed, for example, at a position between a first toe and a second toe of a standard human foot and near a tip of the insole body 100. Alternatively, the positioning information reception unit 220 may be placed at a position between other toes.

Positioning information to be acquired by the positioning information reception unit 220 includes information being received by a radio wave from a GPS, a wireless LAN, a base station, and the like, for example. Herein, a circular polarized planar antenna is widely used for a positioning system “GNSS” using satellites such as a GPS. Note that, the GNSS is an abbreviation for a global navigation satellite system. The circular polarized planar antenna includes, as a component, a dielectric substrate, a radiation element printed and wired on both surfaces of the dielectric substrate, and a ground conductor plate. Such an antenna is a planar antenna called a microstrip antenna. The microstrip antenna is directional and a back surface (adhesive surface) is not capable of receiving a radio wave. Meanwhile, it is desirable to capture as many GPS satellites as possible in order to improve positional accuracy to be acquired based on positioning information. Thus, when an antenna is placed in an insole, it is efficient to turn the positioning information reception unit 220 upward. This placement can be achieved in the tiptoe portion of the insole body 100.

Further, it is desirable that another object does not overlap in a receiving direction of the antenna in order to achieve high positioning accuracy. The tiptoe portion does not contain a foot, and thus the tiptoe portion also satisfies this condition.

In addition, the tiptoe portion is less affected by floor reaction force applied to a foot sole in a walking motion. Thus, it is less likely to cause discomfort due to walking or wearing and, at the same time, it is less likely to receive a load.

For the above reasons, malfunction is less likely to be caused and an acquisition characteristic of the positioning information can be improved by placing the positioning information reception unit 220 in the tiptoe portion of the insole body 100. Note that, in the tiptoe portion, the position between the first toe and the second toe and near the tip of the insole is particularly preferable.

Next, a reason for placing the wireless antenna 230 for transmitting data near a lateral side surface portion of the insole body 100 is described. When the insole-type electronic device is worn, in the lateral side surface portion of a foot, the wireless antenna 230 is placed along the lateral side surface portion of the insole in such a way as to be placed outward from a human body, and thus excellent output efficiency of a radio wave to be transmitted can be achieved. Moreover, it is easy to ensure a linear length in this portion and thus the length of the antenna can be optimally designed for a frequency band of a radio wave to be used. This portion is also less deformed during walking and thus high reliability can be ensured.

Next, a reason for placing the power supply unit 210 in a plantar arch portion of the insole body 100 is described. There is an arch-shaped portion on a foot sole called the plantar arch. The plantar arch is composed of a medial arch formed from a first metatarsal head to a calcaneal tuberosity, a lateral arch formed from a fifth metatarsal head to the calcaneal tuberosity, and an anterior arch formed from the first metatarsal head to the fifth metatarsal head. Therefore, when a foot sole touches the ground by standing or walking, the plantar arch is a portion where a load to be applied is relatively small. The plantar arch has a characteristic that an area of a relatively unloaded region is larger than an edge portion of the insole body 100. Volume of the power supply unit 210 including a battery and the like generally increases as capacity is increased for long-term operation. Thus, by placing the power supply unit 210 in the plantar arch portion, the volume of the power supply can be increased while a load from a foot and effect on wearability are suppressed.

Next, a reason for placing the GND 240 on the back surface of the insole body 100 is described. In a circuit that performs wireless communication, a circuit (front end) that processes a delicate analog signal such as an antenna, a low noise amplifier (LNA) that amplifies a weak and high frequency signal, and a BPF that extracts a carrier wave is incorporated. Herein, the BPF is an abbreviation for a band pass filter. The signal to be handled here is weak and hence it is desirable to suppress deterioration of a passage characteristic and prevent deterioration of a signal characteristic. By providing the GND 240 on the back surface of the insole body 100, a small-amplitude noise generated between the low-noise amplifier unit and an analog front end circuit unit can be eliminated and deterioration of a transmission characteristic can be prevented. Further, when a distance of the GND is short, capacitance increases and transmission loss increases. By providing the GND 240 on the back surface of the insole body 100, a distance between the positioning information reception unit 220 and the GND 240 can be enlarged. As a result, a noise to be generated by the proximity of these components can be prevented, and a passage characteristic between the antenna and the low noise amplifier (LNA) in a wireless communication circuit can be ensured.

Note that, in the configuration according to the present example embodiment, the following modification example may be adopted.
(1) Each configuration unit such as the power supply unit 210 and the wireless antenna 230 may be mounted on and connected to a substrate having flexibility such as the flexible substrate.
(2) The components of the electronic module such as the wireless antenna 230 and other sensors may be formed directly on the flexible substrate 205.
(3) The wireless antenna 230, other sensors, wiring, and the like may be formed directly on the material of the insole body 100.
(4) The positioning information reception unit 220 may be placed on a little toe side in the tiptoe portion.
(5) The power supply unit 210 may use a power generation method without using a battery such as piezoelectric power generation or thermal power generation, wireless power supply, or the like.
(6) When the power supply unit has a small and thin power supply such as a thin battery that is being developed for a wearable device, the power supply unit may be placed at a position other than the plantar arch.
(7) For the heel-protecting portion 110, a material such as polypropylene that has higher rigidity than the material of the insole body formed of a flexible material may be used.
(8) The GND 240 formed on the surface where the insole body 100 comes into contact with the midsole may be attached with a conductive film-shaped or plate-shaped metal or resin. Alternatively, the GND 240 may be formed by a printing method using paste of a conductive metal or resin. Alternatively, the GND 240 may be formed by a plating method. Alternatively, a conductive thread or cloth may be used.
(9) On the surface where the insole body 100 comes into contact with the midsole, a cloth or material different from the insole body 100 may be attached or laminated in order to improve comfort.
(10) In order to provide waterproof/water resisting property for the components of the electronic module, a fluorine-based, urethane-based, polymer-based, silicone-based, rubber-based, or acrylic-based coating may be applied.
(11) In order to store the components of the module, each storage gap to be provided on the insole body may be formed after forming an approximate shape of the insole body 100 by cutting or other methods.

As described above, the present example embodiment is able to provide an insole-type electronic device in which an electronic module is less susceptible to impact and a load and a user can keep wearing the insole-type electronic device safely and comfortably. Then, when the insole-type electronic device is used as a watching device, it is possible to provide an insole-type watching device capable of continuing to function without breaking down while position detection accuracy and communication performance are ensured.

### Fourth Example Embodiment

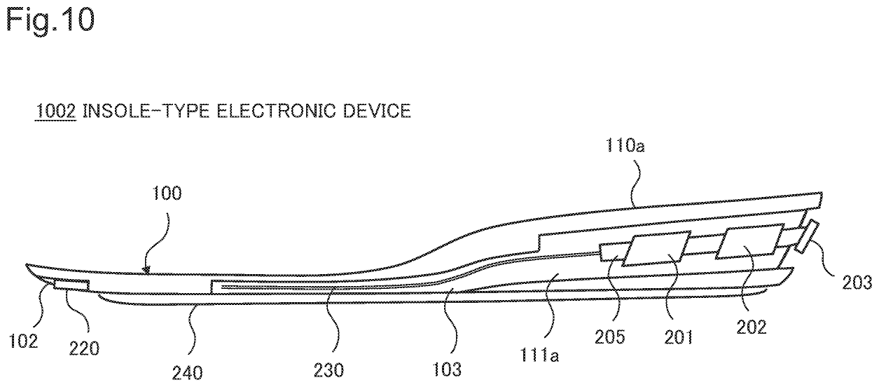

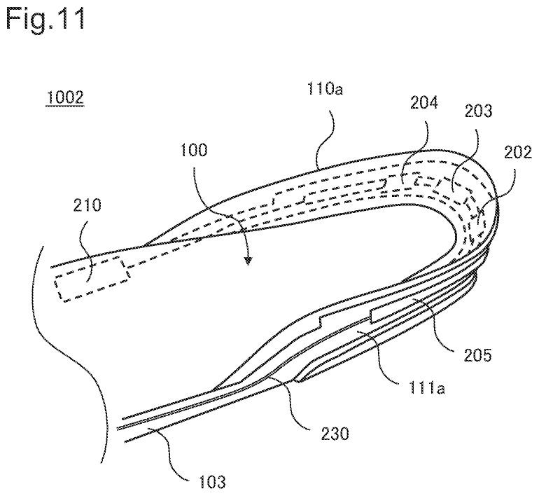

FIG. 10 is a side view illustrating an insole-type electronic device 1002 according to the present example embodiment. FIG. 11 is a perspective view zooming in a heel portion of the insole-type electronic device 1002.

As illustrated in FIGS. 10 and 11, in the insole-type electronic device 1002 according to the present example embodiment, a three-dimensional shaped control unit storage gap 111a having an angle from a vertical direction with respect to the ground is formed in a heel-protecting portion 110. Then, electronic modules 201, 202, and 203 constituting a control unit are placed according to the angle of the three-dimensional shaped control unit storage gap 111a. Such placement may increase a load received from walking, resulting in less reliability as compared with a case where the electronic modules are placed along a side surface being substantially perpendicular to the ground. However, a height of a heel-protecting portion 110a can be lowered, thereby wearability is improved.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2019-055971, filed on Mar. 25, 2019, the disclosure of which is incorporated herein in its entirety by reference.

### REFERENCE SIGNS LIST

1, 10, 100 Insole body
2, 10a, 110 Heel-protecting portion
Electronic module
Heel low-load region
Plantar arch low-load region
Tiptoe low-load region
20 Heel module
Plantar arch module
Tiptoe module
Foot bone
101 Power supply unit storage gap
102 Positioning information reception unit storage gap
103 Wireless antenna storage gap
104, 105 Wiring storage gap
111 Control unit storage gap
200 Control unit
205 Flexible substrate
210 Power supply unit
220 Positioning information reception unit
230 Wireless antenna
240 GND
300, 301 Wiring

What is claimed is:

1. An insole-type electronic device comprising:
a sheet-shaped insole body to be placed on a midsole of a shoe;
a heel-protecting portion extending upward along a perimeter of a rear end of a heel portion of the insole body; and
an electronic module being stored in the heel-protecting portion.

2. The insole-type electronic device according to claim 1, further comprising
a resin layer that separates the electronic module from outside.

3. The insole-type electronic device according to any one of claim 1, wherein
the heel-protecting portion has a surface substantially perpendicular to a bottom surface of the insole body, and
the electronic module is mounted on the surface substantially perpendicular to the bottom surface.

4. The insole-type electronic device according to any one of claim 1, wherein
the heel-protecting portion has a surface inclined at a predetermined angle from a direction substantially perpendicular to a bottom surface of the insole body, and the electronic module is mounted on a surface inclined at a predetermined angle from a direction substantially perpendicular to a bottom surface.

5. The insole-type electronic device according to claim 1, further comprising
a second electronic module connected to the electronic module in at least either one of a plantar arch portion of the insole body and a tiptoe portion of the insole body.

6. The insole-type electronic device according to claim 5, wherein
the second electronic module includes a positioning information reception unit, a power supply unit, and a wireless antenna.

7. The insole-type electronic device according to claim 6, wherein
the positioning information reception unit is placed in a tiptoe portion of the insole body,
the power supply unit is placed in a plantar arch portion of the insole body, and
the wireless antenna is placed in a lateral foot edge portion of the insole body.

8. A watching system comprising:
the insole-type electronic device according to claim 6; and
a position monitoring device that receives positioning information of the insole-type electronic device from the insole-type electronic device.

9. A method for manufacturing an insole-type electronic device, comprising:
forming a sheet-shaped insole body to be placed on a midsole of a shoe;
forming a heel-protecting portion extending upward along a perimeter of a rear end of a heel portion of the insole body; and
storing an electronic module in the heel-protecting portion.

10. The method for manufacturing the insole-type electronic device according to claim 9, further comprising
forming a resin layer that separates the electronic module from outside.

11. The insole-type electronic device according to any one of claim 2, wherein
the heel-protecting portion has a surface substantially perpendicular to a bottom surface of the insole body, and
the electronic module is mounted on the surface substantially perpendicular to the bottom surface.

12. The insole-type electronic device according to any one of claim 2, wherein
the heel-protecting portion has a surface inclined at a predetermined angle from a direction substantially perpendicular to a bottom surface of the insole body, and
the electronic module is mounted on a surface inclined at a predetermined angle from a direction substantially perpendicular to a bottom surface.

13. The insole-type electronic device according to claim 2, further comprising
a second electronic module connected to the electronic module in at least either one of a plantar arch portion of the insole body and a tiptoe portion of the insole body.

14. The insole-type electronic device according to claim 3, further comprising
a second electronic module connected to the electronic module in at least either one of a plantar arch portion of the insole body and a tiptoe portion of the insole body.

15. The insole-type electronic device according to claim 4, further comprising
a second electronic module connected to the electronic module in at least either one of a plantar arch portion of the insole body and a tiptoe portion of the insole body.

16. The insole-type electronic device according to claim 13, wherein
the second electronic module includes a positioning information reception unit, a power supply unit, and a wireless antenna.

17. The insole-type electronic device according to claim 14, wherein
the second electronic module includes a positioning information reception unit, a power supply unit, and a wireless antenna.

18. The insole-type electronic device according to claim 15, wherein
the second electronic module includes a positioning information reception unit, a power supply unit, and a wireless antenna.

19. The insole-type electronic device according to claim 16, wherein
the positioning information reception unit is placed in a tiptoe portion of the insole body,
the power supply unit is placed in a plantar arch portion of the insole body, and
the wireless antenna is placed in a lateral foot edge portion of the insole body.

20. The insole-type electronic device according to claim 17, wherein
the positioning information reception unit is placed in a tiptoe portion of the insole body,
the power supply unit is placed in a plantar arch portion of the insole body, and
the wireless antenna is placed in a lateral foot edge portion of the insole body.
